(19) United States
(12) Patent Application Publication
(10) Pub. No.: US 2021/0208696 A1
(43) Pub. Date: Jul. 8, 2021

(54) OPERATING PEN-SHAPED INPUT DEVICES IN MULTIPLE MODES

(71) Applicant: LENOVO (Singapore) PTE. LTD., New Tech Park (SG)

(72) Inventors: Yoshitsugu Suzuki, Yokohama-shi (JP); Ryohta Nomura, Yokohama-shi (JP); Seiichi Kawano, Yokohama-shi (JP); Yuichi Shigematsu, Yokohama-shi (JP)

(21) Appl. No.: 17/135,715

(22) Filed: Dec. 28, 2020

(30) Foreign Application Priority Data
Jan. 7, 2020 (JP) 2020-000847

(51) Int. Cl. G06F 3/038; G06F 3/0354

(52) U.S. Cl. CPC G06F 3/038; G06F 2203/0381; G06F 3/03543; G06F 3/03545

(57) ABSTRACT

Apparatus and systems for operating pen-shaped input devices in a plurality of set modes are disclosed herein. Various apparatus and systems include an input acceptance unit that receives a pen-based input signal from a pen-shaped input device for operating in a plurality of set modes, the input signal including information on a contact position of the pen-shaped input device on a display screen, a mode decision unit that determines which set mode of the plurality of set modes that the pen-shaped input device is currently operating, and a signal conversion unit that converts the pen-based input signal to a mouse-based input signal in response to the mode decision unit determining that the set mode of the plurality of set modes that the pen-shaped input device is currently operating is a direct mouse mode. Methods for executing the various functions of the apparatus and/or systems are also disclosed herein.

### REFERENCE TO RELATED APPLICATION

This application claims priority to Japanese Patent Application No. JP2020-000847, filed on Jan. 7, 2020, the contents of which are incorporated herein by reference, in their entirety.

### FIELD

The subject matter disclosed herein relates to information processing apparatus and, more particularly, operating pen-shaped input devices in a plurality of set modes.

### DESCRIPTION OF THE RELATED ART

A mouse is generally used as an input device for an information processing apparatus, such as a personal computer and the like devices. In recent years, the use of a pen-shaped input device as an input device for an information processing apparatus such as a tablet PC, a tablet terminal, a smartphone, and the like devices is becoming more common. Conventional pen-shaped input devices allow input operations to be directly performed on a display screen and has the advantage that it can become possible to perform more intuitive input operations.

In many software applications, different functions are allocated to pen-based inputs and mouse-based inputs. For example, in a spreadsheet software application, functions such as a drawing function are allocated to the pen-based input and functions such as a cell selection function are allocated to the mouse-based input. Accordingly, in situations in which a user wishes to use a function that is allocated to the mouse-based input when the user is performing a pen-based input using a pen, it becomes necessary for the user to manually go to the settings menu of the software application and switch the input device from the pen to a mouse so that the mouse operations can be performed by the pen.

### BRIEF SUMMARY

Apparatus and systems for operating pen-shaped input devices in a plurality of set modes are disclosed herein. One apparatus includes an input acceptance unit configured to receive a pen-based input signal from a pen-shaped input device configured to operate in a plurality of set modes, the input signal including information on a contact position of the pen-shaped input device on a display screen, a mode decision unit configured to determine which set mode of the plurality of set modes that the pen-shaped input device is currently operating, and a signal conversion unit configured to convert the pen-based input signal to a mouse-based input signal in response to the mode decision unit determining that the set mode of the plurality of set modes that the pen-shaped input device is currently operating is a direct mouse mode.

A system includes a display device, a processor coupled to the display device and configured to execute an operating system, and a memory device coupled to the display device. The memory device is configured to store an input acceptance unit configured to receive a pen-based input signal from a pen-shaped input device configured to operate in a plurality of set modes, the input signal including information on a contact position of the pen-shaped input device on the display screen, a mode decision unit configured to determine which set mode of the plurality of set modes that the pen-shaped input device is currently operating, and a signal conversion unit configured to convert the pen-based input signal to a mouse-based input signal in response to the mode decision unit determining that the set mode of the plurality of set modes that the pen-shaped input device is currently operating is a direct mouse mode.

Method for operating pen-shaped input devices in a plurality of set modes are also disclosed herein. One method includes receiving, by a processor, a pen-based input signal from a pen-shaped input device configured to operate in a plurality of set modes, the input signal including information on a contact position of the pen-shaped input device on the display screen, determining which set mode of the plurality of set modes that the pen-shaped input device is currently operating, and converting the pen-based input signal to a mouse-based input signal in response determining that the set mode of the plurality of set modes that the pen-shaped input device is currently operating is a direct mouse mode.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram of one embodiment of a tablet terminal;

FIG. 2 is a schematic block of one embodiment of an electronic pen;

FIG. 3 is a schematic diagram illustrating one embodiment of a hardware configuration of the tablet terminal illustrated in FIG. 1;

FIG. 4 is a diagram illustrating one embodiment of a coordinate system of the electronic pen of FIG. 3;

FIG. 5 is a functional block diagram of one embodiment of an input control function illustrating various functions performed by the tablet terminal of FIG. 1;

FIG. 6 is a diagram illustrating one embodiment of a signal conversion processing that can be executed by a signal conversion unit;

FIG. 7 is a diagram illustrating one embodiment of the signal conversion processing that can be executed by the signal conversion unit of FIG. 6;

FIG. 8 is a diagram illustrating another embodiment of the signal conversion processing that can be executed by the signal conversion unit of FIG. 6;

FIG. 9 is a diagram illustrating still another embodiment of the signal conversion processing that can be executed by the signal conversion unit of FIG. 6;

FIG. 10 is a diagram illustrating yet another embodiment of the signal conversion processing that can be executed by the signal conversion unit of FIG. 6;

FIG. 11 is a diagram illustrating one embodiment of a direct mouse mode for an electronic pen;

FIG. 12 is a diagram illustrating one embodiment of a relative coordinate input mode for an electronic pen;

FIG. 13 is a flowchart illustrating one embodiment of processing procedures of input control processing of the tablet terminal of FIG. 1;

FIG. 14 is a schematic diagram illustrating one embodiment of a hardware configuration of the tablet terminal of FIG. 1;

FIG. 15 is a functional block diagram of another embodiment of an input control function illustrating various functions performed by the tablet terminal of FIG. 1; and

FIG. 16 is a diagram illustrating one embodiment of signal conversion processing that is executed by a signal conversion unit operating with an external display device that is coupled to a tablet terminal.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a circuit, module, or system. Furthermore, embodiments may take the form of a program product embodied in one or more computer-readable storage devices storing machine readable code, computer-readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer-readable storage devices. Where a module or portions of a module are implemented in software, the software portions are stored on one or more computer-readable storage devices.

Any combination of one or more computer-readable media may be utilized. The computer-readable medium/media may include one or more computer-readable storage media. The computer-readable storage medium/media may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (e.g., a non-exhaustive and/or non-limiting list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the C programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to one embodiment, an embodiment, or similar language means that a particular feature, structure, or characteristic described in connection with the embodiment is included in at least one embodiment. Thus, appearances of the phrases in one embodiment, in an embodiment, and similar language throughout this specification may, but do not necessarily, all refer to the same embodiment, but mean one or more but not all embodiments unless expressly specified otherwise. The terms including, comprising, having, and variations thereof mean including but not limited to, unless expressly specified otherwise. An enumerated listing of items does not imply that any or all of the items are mutually exclusive, unless expressly specified otherwise. The terms a, an, and the also refer to one or more unless expressly specified otherwise.

In addition, as used herein, the term set can mean one or more, unless expressly specified otherwise. The term sets can mean multiples of or a plurality of one or mores, ones or more, and/or ones or mores consistent with set theory, unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The various embodiments disclosed herein provide an information processing apparatus and an input controlling method for the information processing apparatus that make it possible to realize a direct mouse mode in which the mouse cursor is displayed on the display screen at the position of the pen tip of a pen-shaped input device. An information processing apparatus according to certain embodiments is applicable to a pen-shaped input device that is configured to allow allocation of a plurality of operational modes that can include a direct mouse mode in which a mouse cursor is displayed on a display screen at a position of a pen tip of a pen-shaped input device and to allows mode switching between the direct mouse mode and one or more other operational modes.

Various additional embodiments include, among other components, an input acceptance unit that is configured to accept a pen-based input signal including information related to a contact position of the pen-shaped input device on a display screen, a display information acquisition unit that is configured to acquire display information currently being displayed on the display screen, a mode decision unit that is configured to determine which mode is set to the pen-shaped input device, and a signal conversion unit. The signal conversion unit, in certain embodiments, is configured to convert the pen-based input signal received by the input acceptance unit to an input signal that resembles a mouse-based input on the basis of the information currently being displayed on the display screen and to output the input signal to an operating system (OS) as a mouse-based input signal, in situations in which the mode that is set to the pen-shaped input device is a direct mouse mode.

An input controlling method according to various embodiments is used in an information processing apparatus that provides a pen-shaped input device that is configured to allow allocation of a plurality of modes including a direct mouse mode in which a mouse cursor is displayed on a display screen at a position of a pen tip and to allow mode switching between the direct mouse mode and one or more other modes (e.g., a direct pen mode). In some embodiments, the method includes receiving a pen-based input signal that includes information on a contact position of the pen-shaped input device on a display screen, acquiring display information currently being displayed on the display screen, and determining a mode that is set to the pen-shaped input device. The method further includes converting the pen-based input signal that is received from the pen-shaped input device to an input signal that corresponds to a mouse-based input on the basis of the display information and outputs the input signal to an OS as a mouse-based input signal, in situations in which the mode that is set to the pen-shaped input device is the direct mouse mode. In short, the various embodiments disclosed herein can exhibit such an effect that it becomes possible to realize the direct mouse mode in which the mouse cursor is displayed on the display screen at the position of the pen tip of a pen-shaped input device.

The description of the elements in each figure may refer to elements of proceeding figures. That is, like numbers can refer to like elements in all of the figures, including alternate embodiments of like elements.

In the following description, various embodiments of an information processing device (or an information handling device) and an input controlling method for the information processing device is described with reference to the drawings. In the following description, a tablet terminal is utilized as the information processing apparatus; however, an information processing device is not limited to a tablet terminal and may be, for example, a pad-shaped terminal, a smartphone, and a laptop personal computer (PC), etc., among other computing devices that can include a touch screen that are possible and contemplated herein.

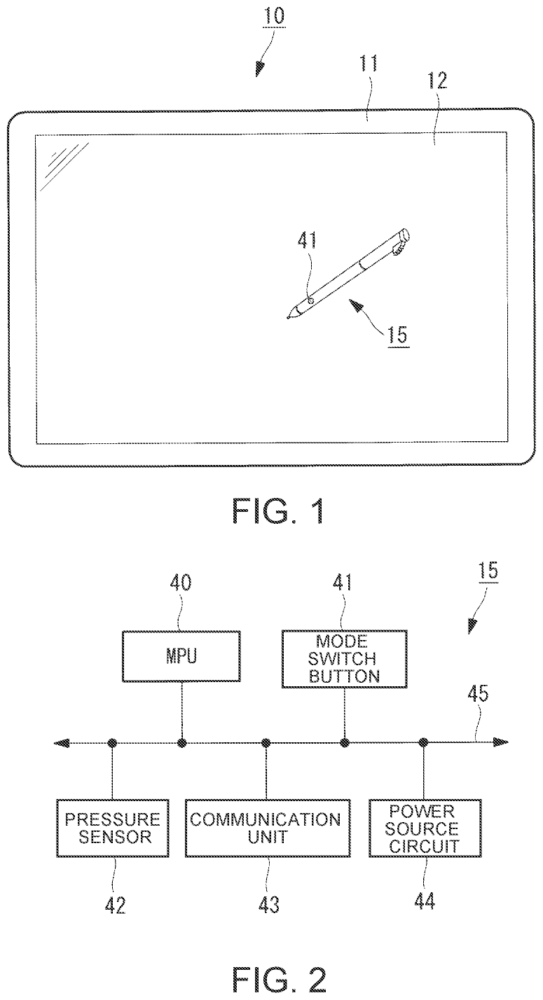

With reference now to the drawings, FIG. 1 is a schematic external view illustrating one embodiment of a tablet terminal 10 including a chassis 11. At least in the illustrated embodiment, the chassis 11 includes a generally rectangular shape and a touch panel display 12 installed on a front face of the chassis 11 and configured to display various display images.

The touch panel display 12, in certain embodiments, includes a display function and an input detection function. Specifically, the display data can be converted to video signals. The various pieces of information that depend on the video signals that are converted in this way are displayed on the touch panel display 12 and various input operations that are performed using an electronic pen 15, also referred to herein as a pen-shaped input device 15, are detected. A surface of the touch panel display 12 functions as an input face that receives and/or accepts the input operations that are performed on the tablet terminal 10 by using the electronic pen 15.

In some embodiments, a camera, a loudspeaker, a microphone, and/or the like devices may be installed on the front face, a side face, and/or a back face of the chassis 11. Further, an operations unit, such as a button and the like capable of turning ON/OFF a power source of the tablet terminal 10, one or more connection units that are connectable with one or more other information processing devices, storage media, and the like devices and are based on the Universal Serial Bus (USB) standard, the High-Definition Multimedia Interface (HDMI®) standard, the Digital Visual Interface (DVI) standard, and the like, and one or more other units may be installed on the side faces of the chassis 11.

The electronic pen 15 can be gripped with the hand of a user and is used as an input device of the tablet terminal 10. The electronic pen 15 may be any suitable type of pen-shaped input device that is known or developed in the future. For example, the electronic pen 15 may be of a passive type or an active type, among other types of pen-shaped input devices that are possible and contemplated herein.

In various embodiments, the electronic pen 15 may operate in a plurality of modes. In certain embodiments, the plurality of modes includes, among other operations, a direct mouse mode in which a mouse cursor is displayed on a display screen at a position corresponding to the pen tip of the electronic pen 15. In some embodiments, the electronic pen 15 is configured to operate in a direct mouse mode and a pen mode, among other operational modes that are possible and contemplated herein.

In various embodiments, the electronic pen 15 is further configured to switch between the direct mouse mode and the pen mode in response to a predetermined operation performed by the user. The electronic pen 15 may be switched between modes using any suitable method and/or technique that is known or developed in the future. In certain embodiments, switching of the set mode is performed by, for example, depressing a mode switch button 41 that is installed on the electronic pen 15. In additional or alternative embodiments, the set mode may be switched by, for example, changing an inclination of the electronic pen 15. In still other additional or alternative embodiments, the set mode of the electronic pen 15 may be switched on the tablet terminal 10 side in addition to and/or not on the electronic pen 15 side.

FIG. 2 is a block diagram illustrating one example of a schematic configuration of an electronic pen 15. As illustrated in FIG. 2, the electronic pen 15 includes, among other components, a Micro Processing Unit (MPU) 40, a mode switch button 41, a pressure sensor 42, a communication unit 43, and a power source circuit 44 coupled to and/or in communication with one another via a bus 45 (e.g., a wired and/or wireless bus). In addition, the electronic pen 15 may further include an acceleration sensor and/or a gyro sensor, etc., among other sensors that are possible and contemplated herein. Further, the MPU 40 controls the operations of the various units that the electronic pen 15 includes by executing a set of predetermined program(s).

The mode switch button 41 is configured to switch the set mode on the electronic pen 15. In situations in which a depressing operation is performed on the mode switch button 41 by the user, a set mode signal (e.g., information on the set mode) that depends on the depressing operation is output. In some embodiments, it is also possible to perform switching of the set mode on the tablet terminal 10 side, which may be in lieu of or in addition to the electronic pen 15 side. Here, it may become unnecessary to output a set mode switch signal from the electronic pen 15.

The pressure sensor 42 is configured to detect that the electronic pen 15 is in contact with the display screen of the tablet terminal 10. Here, the pressure sensor 42 detects contact of the electronic pen 15 with the display screen and then outputs a contact detection signal. In certain embodiments, a contact detection unit that detects the contact of the electronic pen 15 with the display screen is not limited to the pressure sensor 42. That is, the contact of the electronic pen 15 with the display screen may be detected by another unit such as, for example, a push switch, among other devices and/or units that are possible and contemplated herein.

The communication unit 43 is configured to communicate with the tablet terminal 10 and transmit pen-based input information, such as the set mode signal, the contact detection signal, and the like signals to the tablet terminal 10, for example, in accordance with control of the MPU 40. The power source circuit 44 is configured to supply electric power to respective units that configure the electronic pen 15 in accordance with control of the MPU 40.

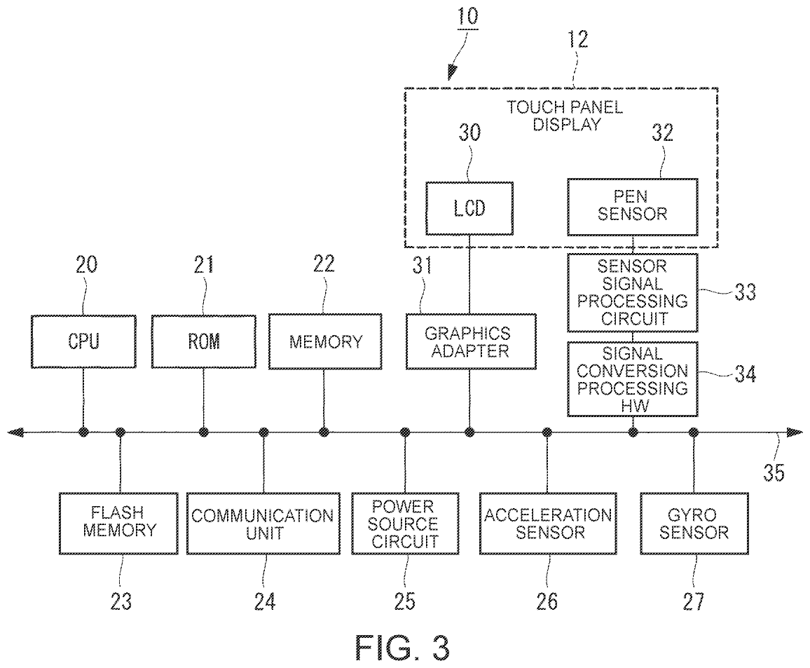

FIG. 3 is a schematic diagram illustrating one embodiment of a hardware configuration of the tablet terminal 10. The tablet terminal 10 includes, among other components, a Central Processing Unit (CPU) 20, a Read Only Memory (ROM) 21, a memory 22, a flash memory 23, a communication unit 24, a power source circuit 25, an acceleration sensor 26, a gyro sensor 27, a Liquid Crystal Display (LCD) 30, a graphics adapter 31, a pen sensor 32, a sensor signal processing circuit 33, and signal conversion processing hardware 34. The respective units are connected/coupled together and/or in directly or indirect communication with one another via a bus 35. In some embodiments, the touch panel display 12 includes the LCD 30 and the pen sensor 32. Although the LCD 30 is exemplified as one example of the display unit in FIG. 3, the display unit is not limited to the LCD 30 and may be, for example, an organic electroluminescence (EL) display, among other types of displays that are possible and contemplated herein. In addition, the tablet terminal 10 may further include a touch sensor and/or the like for detection of one or more finger-based inputs.

The CPU 20 is configured to control one or more operations of the entire tablet terminal 10 by use of an OS that is stored in the flash memory 23 connected to the CPU 20 via the bus 35. The CPU 20 includes a set of functions for executing processing various programs that are stored in the flash memory 23 and/or the like device(s). In certain embodiments, the CPU 20 is configured to execute one or more predetermined programs and thereby executes processing depending on a user's operation that is performed via the touch panel display 12 and/or the like device(s).

The ROM 21 stores therein a Basic Input/Output System (BIOS), various data and so forth. The memory 22 includes a writable memory that is configured by a cache memory and/or a Random Access Memory (RAM) and is utilized as a work area into which an execution program (for example, a control program) that the CPU 20 executes is read and which data is processed based on how the execution program is written.

The flash memory 23, in various embodiments, includes a set of functions for storing one or more operating systems configured to control the operations of the entire tablet terminal 10 such as, for example, Windows®, iOS®, Android®, and the like OS, various drivers for hardware operation of peripherals, specified work-oriented applications, and various data, files, and so forth. In certain embodiments, the tablet terminal 10 may include other memory units such as a Hard Disk Drive (HDD) and so forth as memory units that can supplement or substitute for the flash memory 23.

The communication unit 24 in configured to communicate with one or more other devices over a network. In certain embodiments, the communication unit 24 is configured to receive the pen-based input information (e.g., a contact detection signal, and/or a set mode signal, etc.) from the electronic pen 15 via a communication system that corresponds to the electronic pen 15, for example, by a wireless communication system such as a wireless Local Area Network (LAN), Bluetooth®, and the like wireless communication system(s). In some embodiments, the communication unit 24 and the electronic pen 15 may be connected by a wire and may communicate with each other via a wired communication system, and no particular limitation is put on the type of communication system that can be adopted. The pen-based input information that includes the contact detection signal and the set mode signal is received via the communication unit 24 and thereby it becomes possible to detect the contact of the electronic pen 15 with the display screen of the tablet terminal 10 and the set mode of the electronic pen 15 on the tablet terminal 10 side.

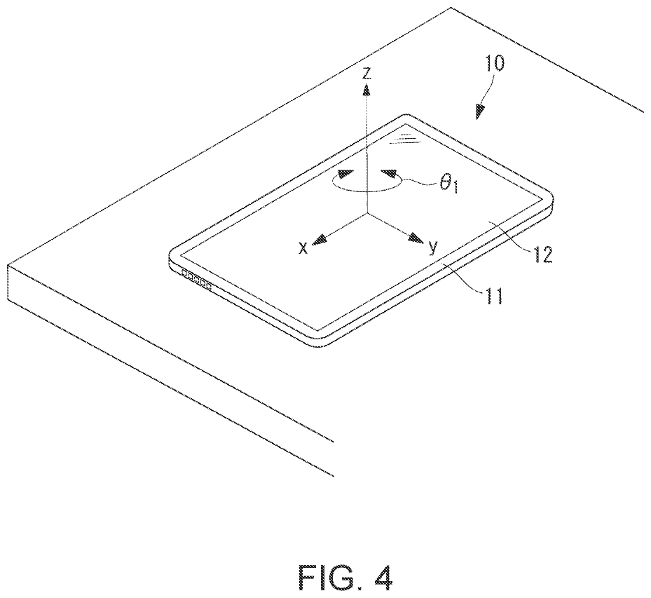

The power source circuit 25 may include an AC adapter, a battery, a charger for charging the battery, a DC/DC converter, and/or the like and is configured to supply the electric power to the respective units in accordance with a set of commands from the CPU 20. The acceleration sensor 26 is configured to detect accelerations that are measured, for example, in an x-direction that is parallel with a longitudinal direction of the touch panel display 12, a y-direction that is parallel with a lateral direction of the touch panel display 12, and a z-direction that is vertical to the x-direction and the y-direction, as illustrated in FIG. 4. The acceleration sensor 26 is further configured to output acceleration values Ax(t), Ay(t) and Az(t) in the x-, y- and z-directions to the CPU 20. In situations in which the tablet terminal 10 is not performing an accelerated motion, the acceleration sensor 26 is configured to detect accelerations in the x-, y- and z-directions, and thereby, it can become possible to detect an inclination and/or angle of the tablet terminal 10 relative to gravity. For example, in situations in which the tablet terminal 10 is stationarily placed on a horizontal stand, the z-direction that indicates a normal direction of the touch panel display 12 (e.g., an input face) is parallel with the direction of gravity.

The gyro sensor 27 is configured to detect the angular velocity of the chassis 11 as it rotates around an intersection of x-, y- and z-axes. In some embodiments, the gyro sensor 27 is configured to detect a rotation angle θ1 around a normal axis of the touch panel display 12 such as, for example, the normal axis that is illustrated in FIG. 4.

The LCD 30 is configured to display video signals that are sent from the graphics adapter 31 as a set of images in accordance with a set of commands from the CPU 20. The graphics adaptor 31 is configured to convert display information to a set of video signals and output the video signal(s) that are converted in this way to the LCD 30 in accordance with a set of commands from the CPU 20.

The pen sensor 32 is configured to detect a contact position (e.g., a touch position, a touch pen position, etc.) of the electronic pen 15 with the input face that is the surface of the touch panel display 12 and, in response thereto, output the contact position to the sensor signal processing circuit 33. In certain embodiments, the pen sensor 32 is configured to detect the contact position of the electronic pen 15 by, for example, an electromagnetic induction system, among other detection techniques that are possible and contemplated herein. In additional or alternative embodiments, the electronic pen 15 is configured to detect the contact position of the electronic pen 15 using an infrared ray system or an ultrasonic system, etc., among other detection techniques that are possible and contemplated herein. In addition, various embodiments can include an Active Electrostatic System (AES) configured to detect contact of a finger, a stylus and/or the electronic pen 15 with the touch panel display 12 using a touch sensor.

The sensor signal processing circuit 33 includes, for example, an integrated circuit (IC) and a processor on the IC can perform various kinds of processing operations by executing a set of programs that are stored in, for example, the flash memory 23 and/or one or more other devices. In certain embodiments, the processor is further configured to control a set of operations for the pen sensor 32.

The signal conversion processing hardware 34, for example, is configured to decide the set mode of the electronic pen 15 on the basis of the pen-based input information that is received from the electronic pen 15 via the communication unit 24. The signal conversion processing hardware 34 is further configured to convert a signal that is transmitted from the pen sensor 32 in accordance with the set mode and, in response thereto, generate an input signal that depends on the set mode. For example, in situations in which the electronic pen 15 is set to the direct mouse mode, the signal conversion processing hardware 34 perform predetermined coordinate transformation processing on the coordinates of the contact position that is detected by the pen sensor 32 based on the display information and so forth on the LCD 30 to generate a mouse-based input signal (e.g., a Human Interface Device (HID) packet). In a further non-limiting example in which the electronic pen 15 is set to a pen mode, the signal conversion processing hardware 34 generates a pen-based input signal (e.g., a HID packet) without performing the coordinate transformation processing that is performed in the direct mouse mode. Various embodiments of the signal conversion processing hardware 34 are described in more detail elsewhere herein.

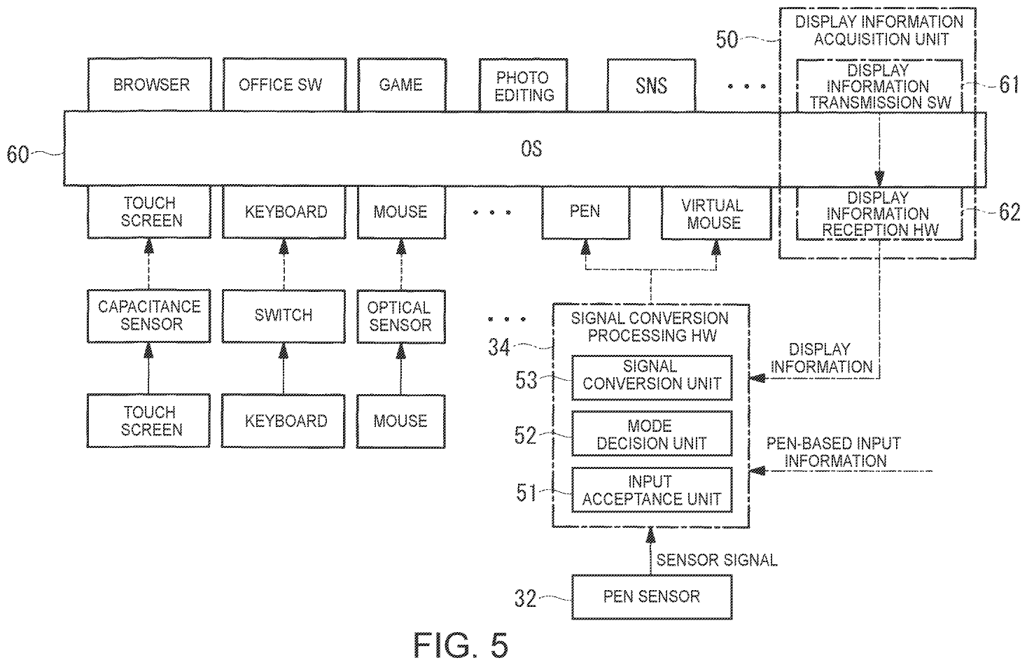

FIG. 5 is a block diagram of one embodiment of an input control function showing various functions that the tablet terminal 10 can perform. As illustrated in FIG. 5, the tablet terminal 10 is configured to accept a set of input operations from one or more input devices such as, for example, a finger, a mouse, a keyboard, and/or the electronic pen 15, etc., among other input devices that are possible and contemplated herein. FIG. 5 further illustrates that a browser, Office software, games, Photo editing, and/or Social Networking Service (SNS), etc. are illustrated as examples of applications that are launched on an OS 60, among other applications that are possible and contemplated herein.

In the following description, the input control function(s) of the tablet terminal 10 that can be realized by using the electronic pen 15 are described in detail with reference to FIG. 5. As shown, the tablet terminal 10 includes, among other components, a display information acquisition unit 50, an input acceptance unit 51, a mode decision unit 52, and a signal conversion unit 53.

The display information acquisition unit 50 is configured to acquire, for example, the display information displayed on the display screen of the tablet terminal 10. The display information acquisition unit 50, in certain embodiments, includes a set of functions that can be realized by software that is implemented as, for example, a resident program. In certain, the display information acquisition unit 50 can be configured by display information transmission software 61 and/or display information reception hardware 62.

The display information transmission software 61 is configured to operate on the OS 60 and acquire, for example, information that relates to a screen resolution and/or information that relates to a rotation direction of the display screen as the display information. In response thereto, the display information that includes these pieces of information is output to the signal conversion processing hardware 34 via the display information reception hardware 62.

The input acceptance unit 51, the mode decision unit 52, and the signal conversion unit 53 include functions that are performed by, for example, the signal conversion processing hardware 34. The input acceptance unit 51 is configured to accept the input signal that includes information on the contact position of the electronic pen 15 from the pen sensor 32.

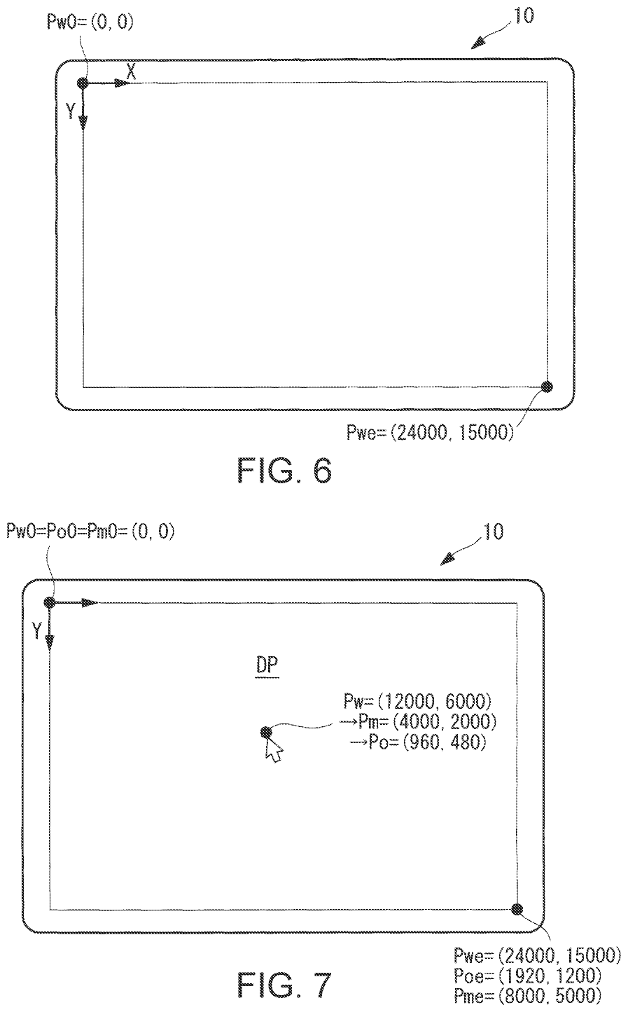

In certain embodiments, a coordinate position of the pen tip of the electronic pen 15 that is based on a sensor coordinate system is input into the input acceptance unit 51 from the pen sensor 32 as the information on the contact position of the electronic pen 15, as illustrated in FIG. 6. Here, the sensor coordinate system indicates a coordinate system that is set in association with an installation region (referred to herein as, a “sensor region”) of the pen sensor 32 of the tablet terminal 10. For example and as illustrated in FIG. 6, in situations in which the tablet terminal 10 is placed in such a manner that a longitudinal direction of the tablet terminal 10 is oriented in a left-right direction with coordinates of an upper-left corner being set as an origin Pw0=(0, 0), the X coordinate is increased as the tablet terminal 10 changes position rightward and a Y coordinate is increased as the tablet terminal 10 changes position downward. This sensor coordinate system is, in some embodiments, an absolute coordinate system and no change occurs on the coordinate system even in situations in which the display screen of the tablet terminal 10 rotates. Notably, although the following description and/or example(s) are provided for situations in which the coordinates of a lower-right corner of the tablet terminal 10 are set to Pwe=(24000, 15000), values of the X and Y coordinates are not limited to the values in the following example(s).

In various embodiments, the input acceptance unit 51 is configured to accept the pen-based input information (e.g., the contact detection signal and/or the set mode signal, etc.) that is received from the electronic pen 15 via the communication unit 24 (see, e.g., FIG. 3). In additional or alternative embodiments, the input acceptance unit 51 is configured to accept the display information that is acquired by the display information acquisition unit 50.

The mode decision unit 52 is configured to decide the set mode of the electronic pen 15. For example, the mode decision unit 52 is configured to decide the set mode of the electronic pen 15 based on the pen-based input information (e.g., the contact detection signal and/or the set mode signal, etc.) that is accepted by the input acceptance unit 51.

The signal conversion unit 53 is configured to perform processing that depends on the set mode decided by the mode decision unit 52 based on an input signal and output the input signal that is processed in this way to the OS 60. For example, in a case in which the mode decision unit 52 decides that the set mode is the pen mode, the signal conversion unit 53 generates a pen-based input signal (e.g., a HID report) from the input signals, such as a pen-tip coordinate signal and so forth, that are accepted by the input acceptance unit 51 and, in response thereto, outputs the generated pen-based input signal to the OS 60. In an additional non-limiting example in which the mode decision unit 52 decides that the set mode is the direct mouse mode, the signal conversion unit 53 converts the input signal that is accepted by the input acceptance unit 51 to an input signal that depends on the mouse-based input based on the display information to generate a mouse-based input signal (e.g., a HID report) and, in response thereto, outputs the generated mouse-based input signal to the OS 60.

Specifically, in situations in which a virtual mouse is set (e.g., in situations in which the set mode is set to the direct mouse mode), the signal conversion unit 53 transforms the coordinates of the pen tip that are included in the input signal that is input from the input acceptance unit 51 to coordinates on a coordinate system that is decided depending on an effective movement region of the virtual mouse and outputs the mouse-based input signal that includes the transformed coordinates to the OS 60. Here, the effective movement region of the virtual mouse is decided by the signal conversion unit 53 depending on an effective display region of the touch panel display 12 and the coordinate system of the virtual mouse is set by the signal conversion unit 53 with an upper-left corner of the effective display region being set as the origin. In the following description, the coordinate system of the virtual mouse is referred to as a, “mouse coordinate system.”

The mouse coordinate system that is decided by the signal conversion unit 53 corresponds to a coordinate system (referred to herein as, a “screen display coordinate system”) that is used in situations in which the OS 60 operates to display the cursor on the display screen and it becomes possible to display the cursor on the position where the pen tip of the electronic pen 15 is brought into contact with the display screen. Here, the OS 60 executes processing that depends on the pen-based input in situations in which the pen-based input signal is input from the signal conversion processing hardware 34 and executes processing that depends on direct-mouse-mode-based input in situation in which the mouse-based input signal is input. Thus, in situations in which the mouse-based input signal is input from the signal conversion processing hardware 34, the OS 60 operates to display the cursor on the pen tip coordinate position that is based on the mouse-based input signal that is input in this manner.

FIG. 7 illustrates one embodiment of a mouse coordinate system. On the mouse coordinate system, for example, in situations in which a mouse movement range is set across the entire sensor region, an origin Pm0=(0, 0) is set on the upper-left corner of the sensor region and a coordinate position Pme=(8000, 5000) is set on the lower-right corner of the sensor region. Notably, the values (8000, 5000) are merely examples and can be set from the mouse side.

In certain embodiments, for example, for situations in which the pen tip is brought into contact with a coordinate position Pw=(12000, 6000) on the sensor coordinate system, the signal conversion unit 53 transforms the coordinate position Pw=(12000, 6000) on the basis of the mouse coordinate system and acquires a coordinate position Pm=(4000, 2000). In response thereto, the signal conversion unit 53 generates a mouse-based input signal that includes the coordinate position Pm that is transformed and outputs the mouse-based input signal to the OS 60. Further, the OS 60 operates to display the cursor on a coordinate position Po=(960, 480) that is based on the screen display coordinate system and corresponds to the coordinate position Pm=(4000, 2000) of the mouse-based input signal. That is, the OS 60 operates to allocate the mouse coordinate system to the entire of the screen display coordinate system to make it possible for the cursor to move across the entire of the display screen. In the example in FIG. 7, the OS 60 operates to allocate the origin Pm0=(0, 0) on the mouse coordinate system to an origin Po0=(0, 0) on the screen display coordinate system and to allocate the maximum-value position Pme=(8000, 5000) on the mouse coordinate system to a maximum-value position Poe=(1920, 1200) on the screen display coordinate system.

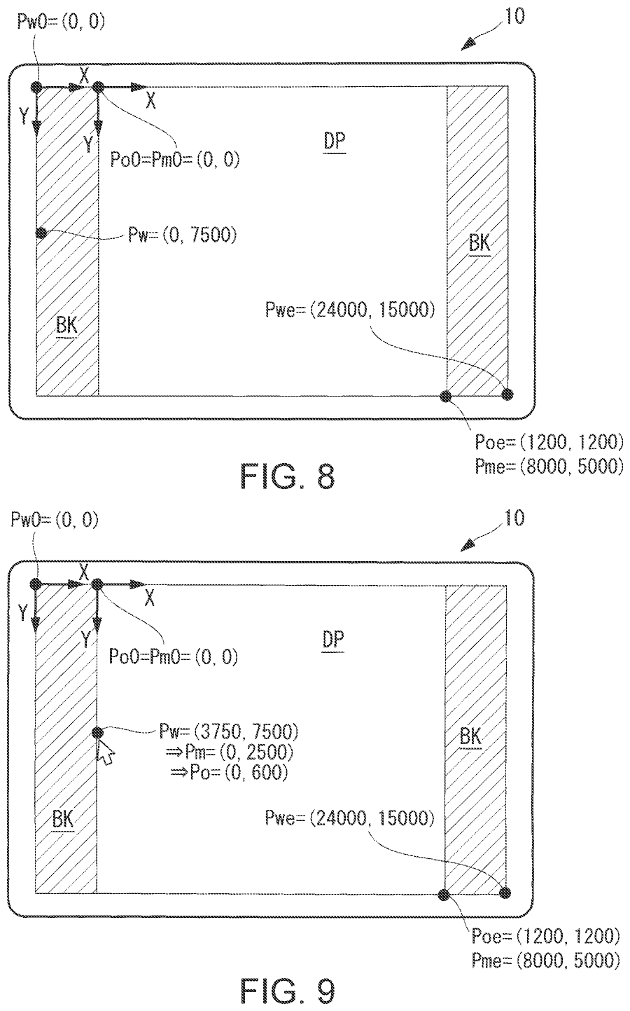

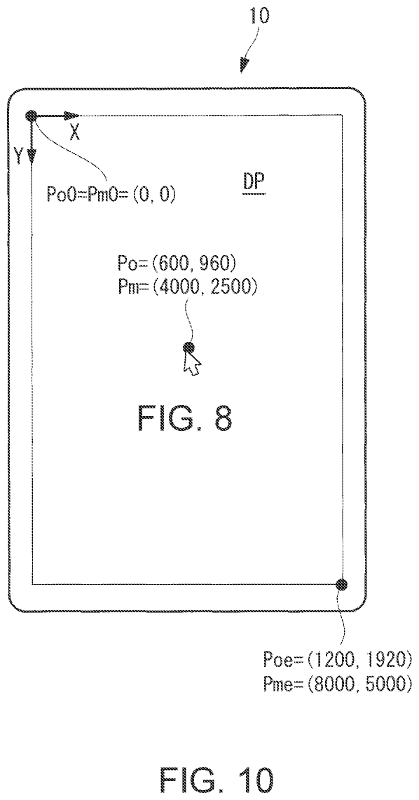

Alternatively, for example, there are situations in which a black belt BK that has a predetermined width is displayed on an end of the display screen depending on the resolution of the display screen of the tablet terminal 10, as illustrated in FIG. 8. In such situations, as described above, it may be necessary for the signal conversion unit 53 to adjust the mouse coordinate system to conform with the screen display coordinate system of the OS 60 to display the mouse cursor on the pen tip contact position on the display screen. That is, as illustrated in FIG. 8, in situations in which the sensor region does not coincide with an effective display region DP and/or for a coordinate system that is on the sensor coordinate system, an upper-left corner of the sensor region is set as the origin Pw0=(0, 0) and/or on the screen display coordinate system of the OS 60, the upper-left corner of the effective display region DP in FIG. 8 can be set as the origin Po0=(0, 0). In other words, a coordinate system that is different from the sensor coordinate system in positioning the origin can be utilized. Here, it may become necessary to adjust the mouse coordinate system to conform with the screen display coordinate system of the OS 60 by using the signal conversion unit 53.

FIG. 8 illustrates a non-limiting example of a situation of how a display screen including a resolution of 1200×1200 pixels can be set on the touch panel display 12 for an original resolution of 1920×1200 pixels. Here, since the sensor coordinate system is independent of screen display and is invariable including no relation to the screen display, the origin Pw0=(0, 0) on the sensor coordinate system is still set on the upper-left corner of the sensor region and the maximum-value position Pwe=(24000, 15000) on the sensor coordinate system is still set on the lower-right corner of the sensor region. In addition, since the OS 60 sets the screen display coordinate system of its own conforming with the effective display region DP, the upper-left corner of the effective display region DP is set as the origin Po0=(0, 0) on the screen display coordinate system and the lower-right corner of the effective display region DP is set as the maximum-value position Poe=(1200, 1200) on the screen display coordinate system. In situations in which setting of the resolution of the display screen is changed, the display information reception software (SW) 61 detects that setting of the resolution of the display screen is changed and display information on the display screen is transmitted to the signal conversion unit 53 via the display information reception hardware (HW) 62. In conjunction with transmission of the display information, the signal conversion unit 53 sets the origin Pm0 that is based on the mouse coordinate system for a position that is the same as the position of the origin Po0 that is based on the screen display coordinate system and, in addition, sets the maximum-value position Pme that is based on the mouse coordinate system for a position that is the same as the position of the maximum-value position Poe that is based on the screen display coordinate system. Here, values of the X and Y coordinates for the coordinate position Pme are optionally set to, for example, 8000 and 5000 (that is, the maximum-value position Pme=(8000, 5000) by the signal conversion unit 53.

In some situations, for example, as illustrated in FIG. 8, in situations in which the contact position of the electronic pen 15 is detected on a coordinate position Pw=(0, 7500) on the sensor coordinate system that is located in the black belt BK region other than the effective display region DP, the signal conversion unit 53 decides whether the coordinate position Pw corresponds to the coordinate position on the mouse coordinate system. In response thereto, as illustrated in FIG. 8, in situations in which the coordinate position Pw does not correspond to the coordinate position on the mouse coordinate system, the signal conversion unit 53 does not generate the mouse-based input signal. That is, the signal conversion unit 53 does not output the mouse-based input signal (e.g., a HID report) to the OS 60.

Alternatively, as illustrated in FIG. 9, in situations in which the contact position of the electronic pen 15 is detected on the coordinate position Pw=(3750, 7500) on the sensor coordinate system in the effective display region DP, the signal conversion unit 53 decides whether the coordinate position Pw corresponds to the coordinate position on the mouse coordinate system, and in situations in which the coordinate position Pw corresponds to the coordinate position on the mouse coordinate system, transforms the coordinates of the coordinate position Pw=(3750, 7500) based on the mouse coordinate system. Thus, the coordinate position Pm=(0, 2500) is obtained as a coordinate position that corresponds to the coordinate position Pw=(3750, 7500). In response thereto, the signal conversion unit 53 generates a mouse-based input signal that includes the coordinate position Pm=(0, 2500) that is based on the mouse coordinate system and outputs the mouse-based input signal to the OS 60.

The OS 60 operates to display the mouse cursor on the coordinate position Po=(0, 600) that is based on the screen display coordinate system and that corresponds to the coordinate position Pm=(0, 2500) that is included in the mouse-based input signal. Thus, it can become possible to display the mouse cursor on the contact position of the electronic pen 15, as illustrated in FIG. 9.

In certain embodiments, the screen display coordinate system of the OS 60 can be changed due to a change in screen display direction of the tablet terminal 10. For example, in situations in which the tablet terminal 10 that displays a landscape screen (see, e.g., FIG. 6) is rotated 90 degrees around the z-axis, a portrait screen as illustrated in FIG. 10 can be displayed. Here, the screen display coordinate system of the OS 60 is rotated 90 degrees from a horizontally disposed state, the coordinate position of the upper-left corner of the display screen is set as the origin Po0=(0, 0) by the OS 60, a Y-axis is set in the longitudinal direction of the tablet terminal 10, and an X-axis is set in a direction that is orthogonal to the longitudinal direction of the tablet terminal 10. In addition, on this coordinate system, the coordinate position of the lower-right corner of the display screen is set to Poe=(1200, 1920).

The display information reception SW 61 is configured to detect the change of coordinate values on the screen display coordinate system and the display information on the screen is transmitted to the signal conversion unit 53 via the display information reception HW 62. In conjunction with the display information transmission, the signal conversion unit 53 sets the origin Pm0=(0, 0) on the mouse coordinate system on the upper-left corner of the display screen that is the same as the origin on the screen display coordinate system and sets the maximum-value position Pme=(8000, 5000) on the mouse coordinate system to the maximum-value position Poe=(1200, 1920) on the screen display coordinate system. Here, the screen display coordinate system of the OS 60 is different from the mouse coordinate system in aspect ratio. However, since the OS 60 sets the movement range of the mouse cursor across the entire display screen, as long as the origins of the screen display coordinate system and the mouse coordinate system coincide with each other and the maximum-value positions of these respective coordinate systems coincide with each other, the difference in aspect ratio is appropriately processed in the OS 60.

For example, in situations in which pen contact that is brought about by the electronic pen 15 or the contact position of the electronic pen 15 is detected on the center of the display screen, by way of example, the signal conversion unit 53 transforms the coordinates on the basis of the mouse coordinate system and obtains the coordinate position Pm=(4000, 2500). In response thereto, the signal conversion unit 53 generates a mouse-based input signal which includes the coordinate position Pm=(4000, 2500) that is based on the mouse coordinate system and outputs the mouse-based input signal to the OS 60.

The OS 60 operates to display the mouse cursor on the coordinate position Po=(600, 960) that corresponds to the coordinate position Pm=(4000, 2500) that is included in the mouse-based input signal. Thus, it can become possible to display the mouse cursor on the contact position of the electronic pen 15, as illustrated in FIG. 10.

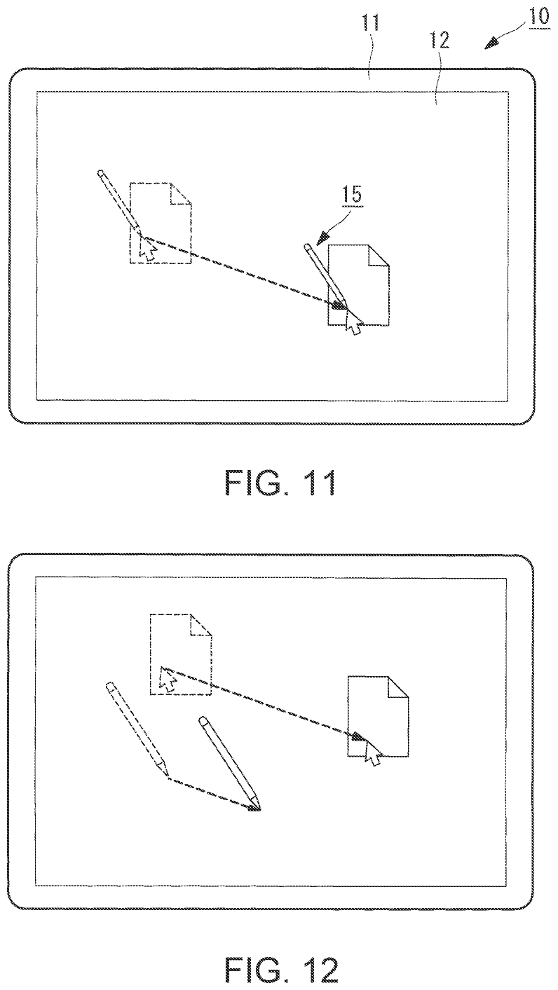

Coordinate transformation, such as the above-described transformation, can be performed by the signal conversion unit 53 and, thus, in situations in which the operations of selecting and moving a file by the electronic pen 15 that is set to the direct mouse mode can be performed on the display screen, the mouse cursor can be displayed on the pen tip, and/or the mouse cursor and the selected file can move as the pen tip moves, as illustrated in FIG. 11. Thus, it can become possible for the user to perform a direct mouse operation using the electronic pen 15 more intuitively compared to performing conventional pseudo-mouse-based inputs that adopt the relative coordinate input mode in which the mouse cursor is displayed on the position that is different from the position where the pen tip is displayed, such as that illustrated in FIG. 12.

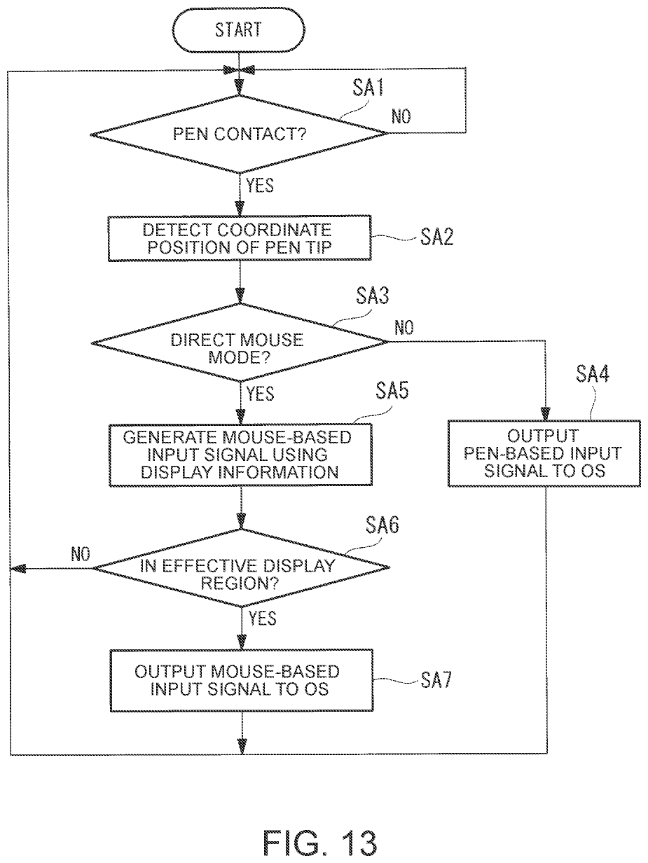

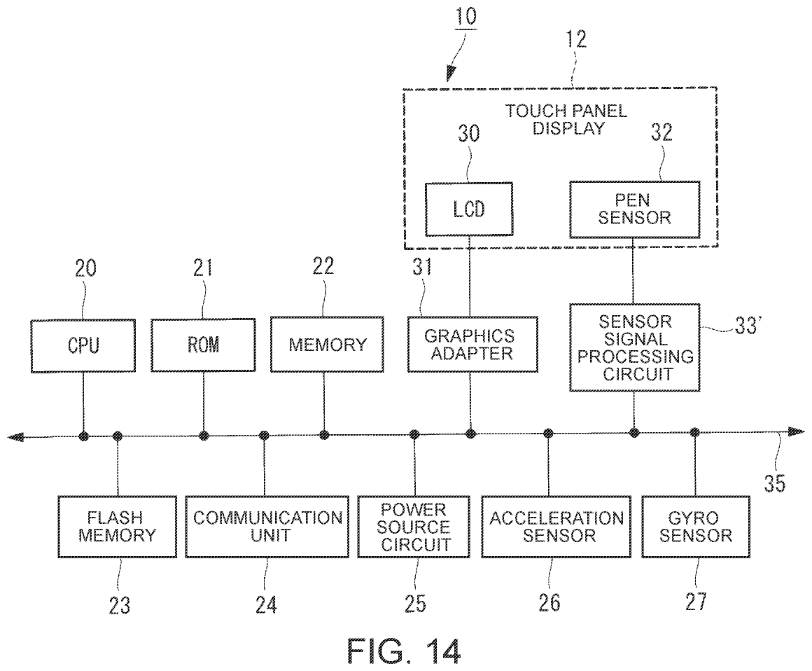

Next, one embodiment of a set of processing procedures of input control processing of the tablet terminal 10 is described with reference to the example flowchart illustrated in FIG. 13. For example, the signal conversion processing hardware 34 is configured to execute a predetermined program to perform an input control process, which is described in the following disclosure.

The process and/or method begins by, in situations in which the user can hold the electronic pen 15 with one hand and may bring the electronic pen 15 into contact with the display screen of the touch panel display 12 in an effort to perform an input operation, with determining whether the pen contact is detected by the pen sensor 32 (e.g., a “YES” in block SA1) and detecting the coordinate position of the pen tip (block SA2). In response thereto, determining whether the set mode of the electronic pen 15 is the direct mouse mode (block SA3). In situations in which it is determined that the set mode is not the direct mouse mode in block SA3, the pen-based input signal is generated and output to the OS 60 (block SA4) and the process returns to block SA1.

Alternatively, in situations in which the set mode is the direct mouse mode (e.g., a “YES” in block SA3), the input signal is converted based on the display information and the mouse-based input signal being generated (block SA5). Thus, the coordinate position of the pen tip is transformed to the coordinate position that depends on the coordinate system that the OS 60 recognizes. In response thereto, a determination of whether the coordinate position of the pen tip is in the effective display region is performed (block SA6) and, in situations in which the coordinate position of the pen tip is in the effective display region (e.g., a “YES” in block SA6), the mouse-based input signal is output to the OS 60 (block SA7) and the process returns to block SA1. Alternatively, in situations in which the coordinate position of the pen tip is not in the effective display region (e.g., a “NO” in block SA6), the process returns to block SA1 without outputting the mouse-based input signal to the OS 60.

As described herein, according to the tablet terminal 10 and the input controlling method according to various embodiments, in situations in which the electronic pen 15 is set to the direct mouse mode, the mouse-based input signal is output from the signal conversion processing hardware 34 to the OS 60. Since the mouse-based input signal is converted in such a manner that the sensor coordinate system on the basis of which the coordinate position of the pen tip is detected coincides with the coordinate system that the OS 60 recognizes (e.g., the screen display coordinate system of the OS 60 in the origin and maximum-value positions by mouse-coordinate-system-based adjustment by the signal conversion unit 53), it can become possible for the OS 60 to display the mouse cursor on the position of the pen tip based on the input mouse-based input signal that is input. As illustrated in FIG. 11, since the mouse cursor is displayed on the position of the pen tip in the direct mouse mode, it can become possible for the user to perform desirable mouse-based input by intuitively operating the electronic pen 15 without feeling that something is unnatural. In addition, it can become possible to facilitate switch functions by making the electronic pen 15 include the direct mouse function and a pen function and it can further become possible to smoothly perform the input operation(s).

Furthermore, the tablet terminal 10 and an input controlling method according to various other embodiments are further described with reference to the following drawings. Notably, in the second embodiment, common symbols that are assigned to configurations that are the same as other configurations are omitted and points that are different from the points in the various other embodiments are described.

FIG. 14 is a schematic diagram illustrating one example of a hardware configuration of the tablet terminal 10 according to certain embodiments. As illustrated in FIG. 14, the tablet terminal 10 according to various embodiments is configured such that the signal conversion processing hardware 34 is omitted and a sensor signal processing circuit 33′ executes the processing that is performed by the signal conversion processing hardware 34.

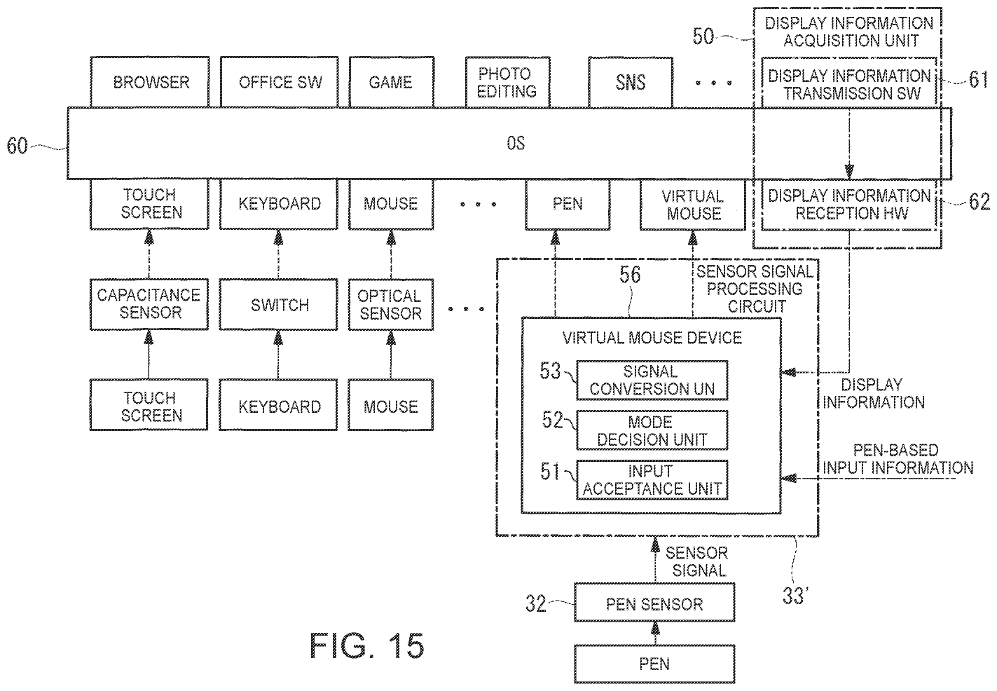

FIG. 15 is an explanatory function block diagram illustrating one example of an input control function included in various functional embodiments of the tablet terminal 10. As illustrated in FIG. 15, the sensor signal processing circuit 33′ includes hardware and firmware that are configured to realize a virtual mouse device 56. A processor of the sensor signal processing circuit 33′ executes a program (e.g., firmware) and thus all of the functions that the virtual mouse device 56 includes can be realized.

The virtual mouse device 56 includes the functions of the input acceptance unit 51, the mode decision unit 52, and the signal conversion unit 53. Thus, in situation in which the set mode of the electronic pen 15 is the pen mode, coordinate transformation processing is not performed on a sensor signal and the pen-based input signal (e.g., the HID report of the electronic pen 15) is output to the OS 60, and in situations in which the set mode of the electronic pen 15 is the direct mouse mode, the sensor signal that is input from the pen sensor 32 is output to the virtual mouse device 56 after having been adjusted to include the coordinates that are based on the mouse coordinate system.

That is, predetermined processing, such as transformation to the coordinate position on the mouse coordinate system, that depends on the screen display coordinate system of the OS 60 and the like are performed on the sensor signal that is input from the pen sensor 32 by the virtual mouse device 56 and thus the mouse-based input signal is generated. Notably, a way of generating the mouse-based input signal may be performed in the same manner as other embodiments discussed elsewhere herein.

Subsequently, the mouse-based input signal (e.g., the HID report of the mouse) is output from the virtual mouse device 56 to the OS 60. In situations in which the direct mouse mode is set to the electronic pen 15, since the mouse-based input signal that corresponds to the direct mouse operation is generated by the sensor signal processing circuit 33′ and is output to the OS 60, it can become possible for the OS 60 to realize the direct mouse operation using the electronic pen 15 by executing processing that depends on the mouse-based input signal.

In addition, it can also be possible to realize the virtual mouse device in filter driver software that works on the OS 60. Here, a filter driver 55 is configured to output the pen-based input signal to the OS 60 based on the screen display information that is received from the display information reception SW 61 and the set mode of the electronic pen 15 or the filter driver 55 outputs the pen-based input signal to the OS 60 as the mouse-based input signal after the coordinates are adjusted.

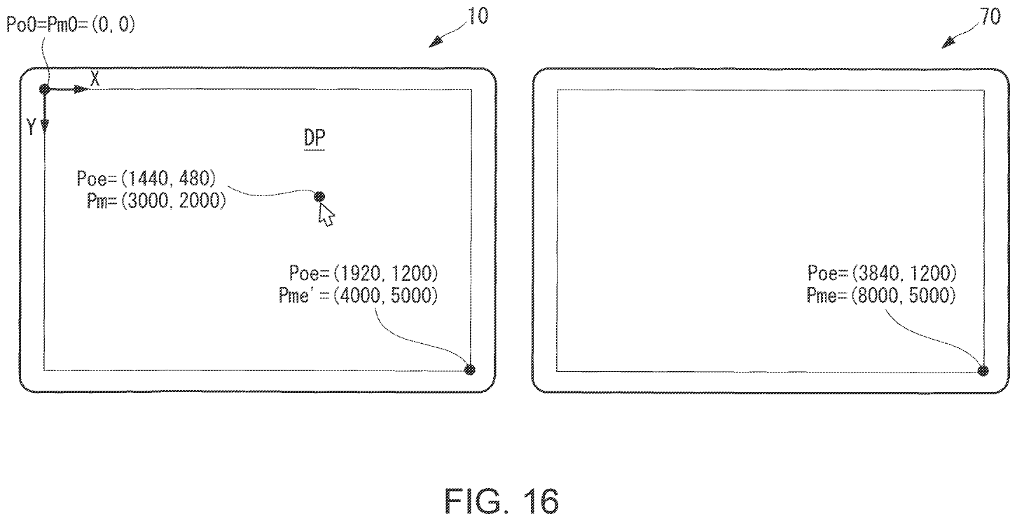

Moreover, various embodiments of the tablet terminal 10 can perform the direct mouse operation using the electronic pen 15 not only in situations in which one display screen is utilized, but also in situations in which, for example, at least one external display device is connected/coupled to the tablet terminal 10 as the external display device (e.g., in situations in which an external display device 70 that does not include a pen sensor connected to the tablet terminal 10, as illustrated in FIG. 16). Here, the origin Pm0=(0, 0) is set on the upper-left corner of the display screen of the tablet terminal 10 and a coordinate position Pme′=(4000, 5000) is set on the lower-right corner of the display screen of the tablet terminal 10. That is, the coordinate position Pme=(8000, 5000) is virtually set on a lower-right corner of the entire of a display screen that is formed by connecting together the display screen of the tablet terminal 10 and a display screen of the external display device 70 and the coordinate position Pme′=(4000, 5000) that the value of the x-coordinate is halved is set as the coordinate position of the lower-right corner of the tablet terminal 10. Further, in situations in which the input operation is performed using the electronic pen 15, the signal conversion unit 53 of the virtual mouse device 56 transforms coordinates that are input using the electronic pen 15 to coordinates that are based on the mouse coordinate system and outputs the mouse-based input signal that includes the coordinates that are obtained after transformation to the OS 60. Thus, it can become possible to display the mouse cursor on the contact position of the electronic pen 15 (e.g., on the display screen of the tablet terminal 10, as illustrated in FIG. 16).

In addition, for example, in situations in which a pen sensor that is configured to detect the coordinate position of the pen tip is mounted on the external display device 70 similar to the tablet terminal 10, it can become possible for the external display device 70 to realize the direct mouse operation by performing the coordinate transformation that is the same as various other embodiments described elsewhere herein. Here, ID information of the external display device 70 is input into the sensor signal. Thus, it can become possible to notify the sensor signal processing circuit 33′ of information that the pen tip has be brought into contact with which coordinate position on which display screen.

Also in situations in which the external display device 70 is connected/coupled to the tablet terminal 10, the virtual mouse device 56 of the sensor signal processing circuit 33′ transforms the coordinate position on the sensor coordinate system that is notified from the pen sensor 32 to the coordinate position that depends on the screen display coordinate system of the OS 60 by using the mouse coordinate system. As a result, in situations in which the external display device 70 is connected/coupled to the tablet terminal 10, it can become possible to realize the direct mouse operation using the electronic pen 15 on the corresponding display screen.

Although the various embodiments are described herein using certain examples, the technical scope of the various embodiments are not limited to the technical scope that is described in the respective examples. That is it is possible to modify the various embodiments in a variety of ways without deviating from the spirit of the various embodiments and the modified embodiments are also included in the technical scope of the various embodiments specifically discussed herein. In addition, forms that are obtained by appropriately combining together the various embodiments are also included in the technical scope of the various embodiments specifically discussed herein. In addition, the flow of the processes/methods of the input control processing that is described in the respective embodiments is merely one example and one or more blocks may be deleted, a new block may be added, and/or the order that the processes is/are executed may be changed without deviating from the spirit of the various embodiments specifically discussed herein.

Further, embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claim is:

1. An apparatus, comprising:
an input acceptance unit configured to receive a pen-based input signal from a pen-shaped input device configured to operate in a plurality of set modes, the input signal including information on a contact position of the pen-shaped input device on a display screen;
a mode decision unit configured to determine which set mode of the plurality of set modes that the pen-shaped input device is currently operating; and
a signal conversion unit configured to convert the pen-based input signal to a mouse-based input signal in response to the mode decision unit determining that the set mode of the plurality of set modes that the pen-shaped input device is currently operating is a direct mouse mode.

2. The apparatus claim 1, further comprising a display information acquisition unit configured to receive display information currently displayed on the display screen.

3. The apparatus of claim 2, wherein:
the display information includes information on a screen resolution;
the pen-based input signal includes a pen tip coordinate position based on a sensor coordinate system;
the signal conversion unit is further configured to transform the pen tip coordinate position in the pen-based input signal to a coordinate position on a coordinate system in the mouse-based input signal; and
the coordinate position on the coordinate system is based on an effective display region on the display screen using the display information.

4. The apparatus of claim 3, wherein the signal conversion unit is further configured to output the mouse-based input signal including the coordinate position on the coordinate system to an operating system.

5. The apparatus of claim 2, wherein:
the display information includes information on a rotational direction of the display screen;
the pen-based input signal includes a pen tip coordinate position based on a sensor coordinate system;
the signal conversion unit is further configured to transform the pen tip coordinate position in the pen-based input signal to a coordinate position on a coordinate system in the mouse-based input signal; and
the coordinate position on the coordinate system is based on an effective display region on the display screen using the display information.

6. The apparatus of claim 5, wherein the signal conversion unit is further configured to output the mouse-based input signal including the coordinate position on the coordinate system to an operating system.

7. The apparatus of claim 1, wherein:
the signal conversion unit is further configured maintain the pen-based input signal in response to the mode decision unit determining that the set mode of the plurality of set modes that the pen-shaped input device is currently operating is a direct pen mode; and
output the pen-based input signal to an operating system.

8. A system, comprising:
a display device;
a processor coupled to the display device and configured to execute an operating system; and
a memory device coupled to the display device and configured to store:
an input acceptance unit configured to receive a pen-based input signal from a pen-shaped input device configured to operate in a plurality of set modes, the input signal including information on a contact position of the pen-shaped input device on the display screen,
a mode decision unit configured to determine which set mode of the plurality of set modes that the pen-shaped input device is currently operating, and
a signal conversion unit configured to convert the pen-based input signal to a mouse-based input signal in response to the mode decision unit determining that the set mode of the plurality of set modes that the pen-shaped input device is currently operating is a direct mouse mode.

9. The system of claim 8, wherein the memory device is further configured to store a display information acquisition unit configured to receive display information currently displayed on the display screen.

10. The system of claim 9, wherein:
the display information includes information on a screen resolution;
the pen-based input signal includes a pen tip coordinate position based on a sensor coordinate system;
the signal conversion unit is further configured to transform the pen tip coordinate position in the pen-based input signal to a coordinate position on a coordinate system in the mouse-based input signal; and
the coordinate position on the coordinate system is based on an effective display region on the display screen using the display information.

11. The system of claim 10, wherein:
the signal conversion unit is further configured to output the mouse-based input signal including the coordinate position on the coordinate system to the operating system; and
the operating system is configured to execute the mouse-based input signal including the coordinate position on the coordinate system based on the screen resolution.

12. The system of claim 9, wherein:
the display information includes information on a rotational direction of the display screen;
the pen-based input signal includes a pen tip coordinate position based on a sensor coordinate system;
the signal conversion unit is further configured to transform the pen tip coordinate position in the pen-based input signal to a coordinate position on a coordinate system in the mouse-based input signal; and
the coordinate position on the coordinate system is based on an effective display region on the display screen using the display information.

13. The system of claim 12, wherein:
the signal conversion unit is further configured to output the mouse-based input signal including the coordinate position on the coordinate system to the operating system; and
the operating system is configured to execute the mouse-based input signal including the coordinate position on the coordinate system based on the rotational direction of the display screen.

14. The system of claim 8, wherein:
the signal conversion unit is further configured maintain the pen-based input signal in response to the mode decision unit determining that the set mode of the plurality of set modes that the pen-shaped input device is currently operating is a direct pen mode;
output the pen-based input signal to the operating system; and
the operating system is configured to execute the pen-based input signal.

15. A method, comprising:
receiving, by a processor, a pen-based input signal from a pen-shaped input device configured to operate in a plurality of set modes, the input signal including information on a contact position of the pen-shaped input device on the display screen;
determining which set mode of the plurality of set modes that the pen-shaped input device is currently operating; and
converting the pen-based input signal to a mouse-based input signal in response determining that the set mode of the plurality of set modes that the pen-shaped input device is currently operating is a direct mouse mode.

16. The method of claim 8, further comprising:
receiving display information currently displayed on the display screen,
wherein:
the display information includes information on a screen resolution,
the pen-based input signal includes a pen tip coordinate position based on a sensor coordinate system,
the signal conversion unit is further configured to transform the pen tip coordinate position in the pen-based input signal to a coordinate position on a coordinate system in the mouse-based input signal, and
the coordinate position on the coordinate system is based on an effective display region on the display screen using the display information.

17. The method of claim 16, further comprising:
executing, on the display screen, the mouse-based input signal including the coordinate position on the coordinate system based on the screen resolution.

18. The system of claim 8, further comprising:
receiving display information currently displayed on the display screen,
wherein:
the display information includes information on a rotational direction of the display screen,
the pen-based input signal includes a pen tip coordinate position based on a sensor coordinate system,
the signal conversion unit is further configured to transform the pen tip coordinate position in the pen-based input signal to a coordinate position on a coordinate system in the mouse-based input signal, and
the coordinate position on the coordinate system is based on an effective display region on the display screen using the display information.

19. The method of claim 18, further comprising:
executing, on the display screen, the mouse-based input signal including the coordinate position on the coordinate system based on the rotational direction of the display screen.

20. The method of claim 8, further comprising:
maintaining the pen-based input signal in response to determining that the set mode of the plurality of set modes that the pen-shaped input device is currently operating is a direct pen mode; and
executing, on the display screen, the pen-based input signal.
